(19) United States
(12) Patent Application Publication
(10) Pub. No.: US 2026/0365860 A1
(43) Pub. Date: Nov. 19, 2026

(54) BARRIER COATINGS FOR PACKAGING MATERIALS

(71) Applicant: Nabaco Inc., San Marcos, TX (US)

(72) Inventor: Gary BEALL, San Marcos, TX (US)

(21) Appl. No.: 19/488,272

(22) PCT Filed: May 24, 2024
(86) PCT No.: PCT/US2024/031082

§ 371 Date: Nov. 26, 2025

Related U.S. Application Data
(60) Provisional application No. 63/469,089, filed on May 26, 2023.

(51) Int. Cl. C09D 5/04; C09D 7/61; C09D 7/63; C09D 7/80; C09D 129/04

(52) U.S. Cl. CPC C09D 5/04; C09D 7/61; C09D 7/63; C09D 7/80; C09D 129/04

(57) ABSTRACT

A coating composition for packaging materials such as paper, cardboard, and plastics, wherein the composition comprises a thixotropic aqueous mixture comprising at least one smectite clay, a water-soluble polymer, and a cross-linking agent for cross-linking the clay and the polymer; an application method thereof, wherein the composition is applied to packaging materials and treated to cross-link the clay and the polymer; and methods and uses thereof for improving the barrier properties of the packaging material.

### FIELD OF THE INVENTION

The present invention is generally directed toward a composition for application to the surface of packaging materials. The composition forms a coating on the surface of the packaging material that is effective for improving one or more barrier properties of the packaging material, such as for reducing or even preventing the transfer of gas and/or moisture through the surface of the packaging material. The invention also relates generally to methods for making the composition, methods for applying the composition to a packaging material, and uses of the composition, as described herein. More particularly, the invention is directed to paper-based or cardboard-based packaging materials coated with the composition of the invention, which can replace single use plastic packaging commonly used in the produce business. The invention also relates to methods of producing the paper or cardboard coating composition.

### BACKGROUND OF THE INVENTION

It is common practice to use plastic sheets, bags, and microporous plastic sheet and bags in the containers utilized to package and ship produce. This plastic packaging serves multiple functions that vary depending on the type of shipping utilized, the type of fruit, and the type of atmosphere. These functions include acting as a cushion to protect the fruit, maintaining a controlled atmosphere, preventing water loss, and allowing fruit respiration. The majority of these packaging materials are polyethylene or polypropylene based and therefore nonbiodegradable. Since these materials are typically single-use, they present a disposal challenge and are a danger to the environment if not disposed of properly. Single-use plastic packaging is not environmentally sustainable and is being legislated out of existence in major jurisdictions. For example, recent legislation in the European Union has set a target date of 2025 to have all single use plastic eliminated from the produce business.

Paper and cardboard are environmentally sustainable materials but are not suitable as packaging material for produce or meat because they have poor barrier properties. In this regard, paper and cardboard are highly permeable to gases, including water vapor. Further, paper and cardboard absorb fats, oils, or water from meats or produce packaged within them.

Many meat products and produce are shipped in wax coated cardboard boxes. The wax coating improves the barrier properties of the cardboard, in particular the resistance to absorbing fats, oils, or water. Due to the wax coating, these boxes are not recycled and are difficult to dispose of. Therefore, wax coated cardboard boxes are also not environmentally friendly.

It would also be advantageous to improve the barrier properties of porous plastic packaging materials, such as PET used in the manufacture of bottles, particularly water bottles.

Thus, a need exists for a composition and packaging material that has good barrier properties; and may also be environmentally sustainable and suitable to replace single-use plastic packaging used in the produce business.

### SUMMARY OF THE INVENTION

The invention relates generally to compositions, methods, and uses for the manufacture of coated packaging materials, in particular paper, cardboard, or plastic. The methods involve coating the packaging material with a thixotropic aqueous mixture as described herein. The terms “thixotropic aqueous mixture” and “thixotropic aqueous composition” (or more generally “thixotropic mixture” and “thixotropic composition”) are used interchangeably herein to refer to compositions and mixtures of the invention that are thixotropic.

When applied to a surface of the packaging material, the thixotropic aqueous mixture of the invention forms a coating that enhances one or more barrier properties of the coated packaging material, as compared to packaging material that is not coated with the thixotropic aqueous mixture (e.g. as compared to uncoated packaging material). For example, coating a packaging material with a thixotropic aqueous mixture of the invention makes the packaging material less permeable to gases, thereby reducing or preventing exchange through the packaging material of gases such as oxygen, carbon dioxide, and/or water vapor. Thereby, packaging materials coated with a thixotropic aqueous mixture of the invention advantageously protect their contents from dehydration and/or oxidation, and are suitable for maintaining a controlled atmosphere within the package. Accordingly, the thixotropic aqueous mixture of the invention, and corresponding methods and uses of the invention, are particularly well-suited for improving the shelf-life of a packaged agricultural product, such as produce. A further advantage of the thixotropic aqueous mixtures of the invention is that they form coatings that retain their integrity and barrier properties under conditions of high humidity.

According to a first aspect of the present invention, there is provided a thixotropic aqueous mixture, comprising: a) at least one smectite clay; b) a water-soluble polymer; and c) a cross-linking agent capable of cross-linking the smectite clay to the polymer. A thixotropic aqueous mixture necessarily also comprises water, and optionally comprises further liquid components such as one or more solvents, buffers, etc. As described herein, the thixotropic aqueous mixture is suitable for coating a surface of a packaging material, for example to provide a barrier coating.

The invention also provides methods of making a thixotropic aqueous mixture of the invention, and thixotropic aqueous mixtures made by the methods of the invention. Therefore, according to a second aspect of the invention, there is provided a method of making a thixotropic aqueous mixture, which generally comprises dispersing in water: at least one smectite clay, a water-soluble polymer, and a cross-linking agent capable of cross-linking the smectite clay to the polymer. In some embodiments, the method comprises: a) dispersing the smectite clay in water to form a smectite clay dispersion; b) adding the cross-linking agent to the smectite clay dispersion and adjusting the pH of the smectite clay dispersion to link the cross-linking agent to the surface of the smectite clay, to form a surface-modified smectite clay dispersion; and c) adding the water-soluble polymer to the surface-modified smectite clay dispersion. In some embodiments, after making the thixotropic aqueous mixture, the method further comprises applying said mixture to a surface of a packaging material.

According to a third aspect of the invention, there is provided a method for preparing a coated packaging material, such as a coated paper, coated cardboard, or coated plastic, wherein the method comprises: i) applying a thixotropic aqueous mixture to a surface of the packaging material, wherein the thixotropic aqueous mixture comprises: a) at least one smectite clay; b) a water soluble polymer; and c) a cross-linking agent capable of cross-linking the smectite clay to the water-soluble polymer; and ii) heat-treating the surface of the packaging material to cross-link the water-soluble polymer to the smectite clay. The method optionally comprises a first step of making the thixotropic aqueous mixture, such as by a method according to the second aspect of the invention.

Coating a packaging material with a thixotropic aqueous mixture of the invention confers one or more advantageous properties, as described herein. For example, coating a packaging material with a thixotropic aqueous mixture of the invention may improve the barrier properties of the packaging material-that is to say, the thixotropic aqueous mixture forms a barrier coating on the surface of the packaging material. Therefore, in a fourth aspect, the invention provides a method of improving one or more barrier properties of a packaging material, such as paper, cardboard, or plastic, wherein the method comprises: i) applying a thixotropic aqueous mixture to a surface of the packaging material, wherein the thixotropic aqueous mixture comprises: a) at least one smectite clay; b) a water soluble polymer; and c) a cross-linking agent capable of cross-linking the smectite clay to the water-soluble polymer; and ii) heat-treating the surface of the packaging material to cross-link the water-soluble polymer to the smectite clay; thereby forming a coated packaging material; whereby one or more barrier properties of the coated packaging material is improved, compared to uncoated packaging material. For example, the one or more barrier properties of the packaging material is gas permeability, wherein the gas permeability of the coated packaging material is reduced, compared to uncoated packaging material. In some embodiments, the method comprises a first step of making the thixotropic aqueous mixture, such as by a method according to the second aspect of the invention.

The thixotropic aqueous mixture can be applied to the surface of the packaging material by any means known in the art, such as using a dip tank, spray bar, brush bed, inkjet printer, doctor knife, roto gravure, or any combination thereof. In some embodiments of third and fourth aspects of the invention, the method comprises applying the thixotropic aqueous mixture to the surface of the packaging material using a dip tank and/or a spray bar.

In a fifth aspect, the invention provides the use of a thixotropic aqueous mixture comprising: a) at least one smectite clay, b) a water-soluble polymer, and c) a cross-linking agent capable of cross-linking the smectite clay to the polymer, as a coating for a packaging material, or for improving one or more barrier properties of a packaging material. For example, the thixotropic aqueous mixture is useful for reducing the permeability of packaging materials such as paper, cardboard, or porous plastics, as compared to the same packaging material that is not coated with the thixotropic aqueous mixture of the invention (e.g., lacking any barrier coating).

The invention further provides, in a sixth aspect, packaging materials coated with a thixotropic aqueous mixture of the invention. For example, the invention provides paper, cardboard, or plastic, coated with a thixotropic aqueous mixture comprising smectite clay, a water-soluble polymer, and a cross-linking agent capable of cross-linking the smectite clay to the polymer. The coated paper and cardboard of the invention are particularly useful for packaging produce, such as fruit, as an alternative to plastic packaging materials used in the produce business. The coated plastic of the invention is particularly well suited for packaging liquids, such as drinks. Accordingly, the invention also provides, in a seventh aspect, a box, carton, tray, bag, or bottle comprising a packaging material coated with a thixotropic aqueous mixture of the invention.

### DETAILED DESCRIPTION

The following detailed description is presented to enable any person skilled in the art to make and use the invention. For purposes of explanation, specific details are set forth to provide a thorough understanding of the present invention. However, it will be apparent to one skilled in the art that these specific details are not required to practice the invention. Descriptions of specific applications are provided only as representative examples. Various modifications to the preferred embodiments will be readily apparent to one skilled in the art, and the general principles defined herein may be applied to other embodiments and applications without departing from the scope of the invention. The present invention is not intended to be limited to the embodiments shown, but is to be accorded the widest possible scope consistent with the principles and features disclosed herein.

It has been unexpectedly discovered that mixtures of certain water-soluble polymers and smectite clays that form highly thixotropic fluids in water, when coated on paper, improve one or more barrier properties of the paper to match that of plastic or other packaging used in the produce industry. The coated paper functions as a cushion for the produce to avoid abrasion or bruising. The coated paper is also compostable and does not require disposal in a landfill. As described herein, the resistance of the coating to conditions of high humidity is improved by cross-linking the smectite clay and the water-soluble polymer. The inclusion of a cross-linking agent, to cross-link the smectite clay to the water-soluble polymer, is demonstrated to overcome the problems of tackiness and poor barrier properties in humid conditions. Similar advantages are achieved when the thixotropic aqueous mixture of the invention is coated onto cardboard. As described herein, the barrier properties of porous plastic packaging materials, such as PET used in the manufacture of bottles, are also improved by coating with the thixotropic aqueous mixture of the invention. Therefore, the presently disclosed invention provides a solution to the problem of providing a packaging material with improved barrier properties; and in some aspects solves the problem of providing an alternative to plastic packaging, particularly when used for packaging produce.

In a first aspect, the invention provides a thixotropic aqueous mixture comprising: a) at least one smectite clay; b) a water-soluble polymer; and c) a cross-linking agent capable of cross-linking the smectite clay to the polymer.

The thixotropic aqueous mixture is suitable and effective for coating a packaging material, in particular for forming a barrier coating on a surface of the packaging material. Accordingly, the thixotropic aqueous mixture may also be referred to as a coating composition, such as a barrier coating composition. When applied to a surface of a packaging material, such as paper, cardboard or plastic (e.g., porous plastic) the thixotropic aqueous composition forms a barrier coating, such as a gas barrier coating, on the surface of the packaging material. Various barrier properties conferred by the coating are described herein. For example, when applied to a surface of a packaging material, the thixotropic aqueous composition is effective for as a gas barrier, for protecting the packaging material from transfer of oxygen and/or carbon dioxide through the packaging material, or for retaining a protective atmosphere within the packaging material. In some embodiments, the thixotropic aqueous composition is effective for protecting the packaging material from moisture loss (e.g., water loss) through the packaging material. If the packaging material packages, or is intended for packaging, an agricultural product such as produce, or a food or drink product, the one or more barrier properties that are conferred to the packaging material by coating with the thixotropic aqueous mixture of the invention are useful for protecting the product from dehydration and/or oxidation, and/or for improving the shelf-life of the product, as compared to packaging material that is not coated with the thixotropic aqueous mixture of the invention.

The term “thixotropic”, as used herein, refers to mixtures having non-Newtonian fluid dynamics whose flow properties, such as apparent viscosity, change with shear rate and duration of shear. The thixotropy of the aqueous mixture is critical for achieving the desired barrier properties. The high shear imparted during preparation of the mixture and/or during application of the mixture to a surface of the packaging material lowers the viscosity of the thixotropic aqueous mixture and lessens the resistance to flow. For example, when spraying the coating mixture onto the surface of a packaging material using a spray gun, the shear imparted by a pump and spray nozzles lowers the viscosity of the aqueous thixotropic mixture and lessens the resistance to flow during spraying (i.e., the thixotropic mixture is thin when is it dispensed through the spray nozzle). Once the spray impinges upon the surface of the packaging material, the viscosity of the thixotropic aqueous mixture recovers, and the thixotropic aqueous mixture forms a coating or film on the surface of the packaging material. The method may further comprise drying the composition following application (e.g., by applying heat), but more typically the composition is left to dry naturally under ambient conditions. A brush (e.g., brush bed) may be used to further smooth out the coating on the surface of the packaging material, making the coating more comprehensive. Moreover, brushing reorientates the platelets of the smectite clay to be parallel to the surface of the packaging material (i.e., aligned with the surface of the packaging material), which reinforces the coating.

The cross-linking agent in the thixotropic aqueous mixture of the invention is any agent that is capable of cross-linking the smectite clay to the water-soluble polymer.

Examples of cross-linking agents that have this property include amino carboxylic acids (also referred to herein as amino acids) and their ethyl esters. As used herein, the term amino acid (or amino carboxylic acid) encompasses standard amino acids (e.g., lysine) and also derivatives and analogues thereof (e.g., aminocaproic acid, also known as aminohexanoic acid) that possess an amine group and a carboxylic acid group. The amine group of the amino acid can ion exchange with sodium on the surface of the smectite clay, and the carboxyl group can form an ester linkage to the water-soluble polymer, thereby cross-linking the surface of the smectite clay to the polymer. In some embodiments, the amine group of the cross-linking agent is protonated by adjusting the pH of the thixotropic aqueous mixture (or a pre-mix of smectite clay and cross-linking agent) to allow the amine group to the ion exchange onto the surface of the clay. Heat-treatment, optionally under vacuum, may be used to initiate the formation of an ester linkage between the COOH group of the cross-linking agent and the polymer.

Accordingly, in some embodiments of the invention, the cross-linking agent is an amino acid. In some embodiments, the cross-linking agent is selected from aminocaproic acid, aminocaproic acid ethyl ester, and lysine. The Examples of the application demonstrate good results using thixotropic aqueous mixtures comprising aminocaproic acid or its ethyl ester.

In some embodiments where the packaging material comes into contact with a product intended for human or animal consumption, a food grade amino acid, such as food grade lysine, may be particularly suitable. The term “food grade”, as used herein, refers to a substance that is safe for human or animal consumption and that is permitted to come into direct contact with food meant for human or animal consumption.

The thixotropic aqueous mixture comprises a smectite clay. Smectite clays useful in the invention include montmorillonite, Laponite (lithium sodium magnesium silicate, Na_{0.7}Si₈Mg_{5.5}Li_{0.3}O₂₀(OH)₄), or hectorite, or a mixture of any two or more thereof. In some embodiments, the smectite clay is montmorillonite, such as sodium montmorillonite. In some embodiments, the smectite clay is Laponite.

In some embodiments, some or all of the smectite clay in the thixotropic aqueous mixture is surface-modified by a cross-linking agent, such as an amino acid as described herein. More specifically, in some embodiments, the cross-linking agent is linked to the surface of the smectite clay by ion exchange between the amine group of the cross-linking agent and sodium ions on the surface of the smectite clay. Accordingly, in these embodiments, the smectite clay in the thixotropic aqueous mixture comprises or consists of a surface-modified smectite clay.

The thixotropic aqueous mixture of the invention also comprises a water-soluble polymer. In some embodiments, the water-soluble polymer is a synthetic or semi-synthetic polymer. One example of a synthetic water-soluble polymer useful in the invention is polyvinyl alcohol (PVOH). Thus, in some embodiments, the thixotropic aqueous mixture of the invention comprises PVOH. The PVOH may be food grade PVOH. The term “food grade”, as used herein, refers to a substance that is safe for human or animal consumption and that is permitted to come into direct contact with food meant for human or animal consumption.

In other embodiments, the water-soluble polymer is a natural water-soluble polymer. The term “natural” or “naturally-occurring”, as used in this context, refers to a water-soluble polymer that occurs in nature, or is derived from nature, and is not made or caused by humankind. This term does not require the polymer to be “obtained directly from nature”. A “natural” or “naturally-occurring” water-soluble may be nature-identical but this is not essential. Examples of naturally-occurring water-soluble polymers include polysaccharides such as gum Arabic and pectin. Thus, in some embodiments, the thixotropic aqueous mixture of the invention comprises gum Arabic or pectin. The polysaccharide may be a food grade polysaccharide. The term “food grade”, as used herein, refers to a substance that is safe for human or animal consumption and that is permitted to come into direct contact with food meant for human or animal consumption.

In some embodiments, the thixotropic aqueous mixture of the invention comprises: a) montmorillonite or Laponite; b) polyvinyl alcohol (PVOH); and c) aminocaproic acid or its ethyl ester. Exemplary thixotropic aqueous mixtures of the invention comprise: a) montmorillonite; b) PVOH; and c) aminocaproic acid or its ethyl ester. Further exemplary thixotropic aqueous mixtures of the invention comprise: a) Laponite; b) PVOH; and c) aminocaproic acid.

In some embodiments, some or all of the smectite clay in the thixotropic aqueous mixture is surface-modified by reaction with the cross-linking agent (e.g., amino acid, such as aminocaproic acid or its ethyl ester). In some embodiments, the thixotropic aqueous mixture of the invention comprises: a) surface-modified montmorillonite or Laponite; and b) polyvinyl alcohol (PVOH). Exemplary thixotropic aqueous mixtures of the invention comprise: a) surface-modified montmorillonite; and b) PVOH. Further exemplary thixotropic aqueous mixtures of the invention comprise: a) surface-modified Laponite; and b) PVOH.

In some embodiments, the smectite clay (e.g., surface-modified smectite clay) is present in the thixotropic aqueous mixture in an amount from 0.5 to 3.5 wt. %, optionally from 1.0 to 3.0 wt. %, optionally in an amount of (or of about) 2 wt %. For example, the thixotropic aqueous mixture may comprise montmorillonite or Laponite in an amount from 0.5 to 3.5 wt. %, optionally from 1.0 to 3.0 wt. %, optionally in an amount of (or of about) 2 wt %. In some embodiments, the thixotropic aqueous mixture comprises montmorillonite (e.g. sodium montmorillonite) or Laponite in an amount of about 2 wt. %.

In some embodiments, the water-soluble polymer is present in the thixotropic aqueous mixture in an amount from 1.5 to 4.5 % wt. %, optionally from 2.0 to 4.0 wt. %, optionally in an amount of (or of about) 3 wt %. For example, the thixotropic aqueous mixture may comprise PVOH in an amount from 1.5 to 4.5 % wt. %, optionally from 2.0 to 4.0 wt. %, optionally in an amount of (or of about) 3 wt. %. In some embodiments, the thixotropic aqueous mixture comprises PVOH in an amount of about 3 wt. %.

Accordingly, in some embodiments, the thixotropic aqueous mixture comprises montmorillonite or Laponite (e.g., surface-modified montmorillonite or Laponite) in an amount from 0.5 to 3.5 wt. %, optionally from 1.5 to 3 wt. %, optionally in an amount of (or of about) 2 wt. %, and PVOH in an amount from 1.5 to 4.5 % wt. %, optionally from 2.0 to 4.0 wt. %, optionally in an amount of (or of about) 3 wt. %. For example, the thixotropic aqueous mixture may comprise montmorillonite (e.g. sodium montmorillonite) or Laponite in an amount of about 2 wt. % and PVOH in an amount of about 3 wt. %.

In some embodiments, the cross-linking agent (e.g., amino acid) is present in thixotropic aqueous mixture in an amount from 0.1 to 0.4 wt. %, optionally from 0.15 to 0.35 wt. %, optionally in an amount of (or of about) 0.25 wt. %. For example, the thixotropic aqueous mixture may comprise aminocaproic acid, aminocaproic acid ethyl ester, or lysine in an amount from 0.1 to 0.4 wt. %, optionally from 0.15 to 0.35 wt. %, optionally in an amount of (or of about) 0.25 wt. %. In some embodiments, the thixotropic aqueous mixture comprises aminocaproic acid or its ethyl ester in an amount of about 0.25 wt. %.

Accordingly, in some embodiments, the thixotropic aqueous mixture comprises montmorillonite or Laponite in an amount from 0.5 to 3.5 wt. %, optionally from 1.0 to 3 wt. %, optionally in an amount of (or of about) 2 wt %; PVOH in an amount from 1.5 to 4.5 % wt. %, optionally from 2.0 to 4.0 wt. %, optionally in an amount of (or of about) 3 wt %; and an amino acid such as aminocaproic acid, aminocaproic acid ethyl ester, or lysine, in an amount from 0.1 to 0.4 wt. %, optionally from 0.15 to 0.35 wt. %, optionally in an amount of (or of about) 0.25 wt. %. For example, a thixotropic aqueous mixture of the invention may comprise montmorillonite (e.g. sodium montmorillonite) in an amount of about 2 wt. %; PVOH in an amount of about 3 wt. %; and aminocaproic acid or its ethyl ester in an amount of about 0.25 wt. %. For example, a thixotropic aqueous mixture of the invention may comprise Laponite in an amount of about 2 wt. %; PVOH in an amount of about 3 wt. %; and aminocaproic acid in an amount of about 0.25 wt. %.

The ratio of smectite clay to water-soluble polymer in the thixotropic aqueous mixture of the invention is typically between 1:4 and 4:1, such as between 1:1 and 1:3. In some embodiments, the ratio of smectite clay to water-soluble polymer is (or is about) 2:3. For example, a thixotropic aqueous mixture of the invention may comprise montmorillonite or Laponite and PVOH in a ratio of about 2:3.

In some embodiments, the ratio of smectite clay to cross-linking agent (e.g., amino acid) in the thixotropic aqueous mixture of the invention is from 4:1 to 13:1, optionally from 6:1 to 12:1, optionally about 8:1; and/or the ratio of water-soluble polymer to cross-linking agent in the thixotropic aqueous mixture of the invention is from 8:1 to 20:1, optionally from 9:1 to 16:1, optionally about 12:1. For example, a thixotropic aqueous mixture of the invention may comprise montmorillonite or Laponite, and aminocaproic acid or its ethyl ester, in a ratio of about 8:1; and/or a thixotropic aqueous mixture of the invention may comprise PVOH, and aminocaproic acid or its ethyl ester, in a ratio of about 12:1. In some embodiments, the ratio of smectite clay: water-soluble polymer: cross-linking agent (e.g., amino acid) in a thixotropic aqueous mixture of the invention is (or is about) 8:12:1. For example, the thixotropic aqueous mixture of the invention may comprise montmorillonite (e.g., sodium montmorillonite), PVOH, and aminocaproic acid or its ethyl ester in a ratio of about 8:12:1. For example, the thixotropic aqueous mixture of the invention may comprise Laponite, PVOH, and aminocaproic acid in a ratio of about 8:12:1.

The thixotropic aqueous mixture of the invention comprises water. The smectite clay and other solids are dispersed in the water. The water may further act as a solvent for the water-soluble polymer. In some embodiments, the thixotropic aqueous mixture comprises water and a further food grade solvent, such as ethanol. If ethanol is present, it makes up no more than 25% of the total solvent in the mixture. In some embodiments, the thixotropic aqueous mixture of the invention is a dispersion comprising 1-8% solids; optionally 1-5% solids.

When applied to a surface of a packaging material, the thixotropic aqueous mixture of the invention forms a coating on the surface, which acts as a barrier coating, such as a gas barrier coating. In some embodiments, the coating is transparent. The term “transparent”, as used herein, refers to a coating that allows light to pass through. As such, the coating film on the surface may be undetected by the human eye, or it may have a slightly “shiny” surface that differentiates it from an uncoated surface. Therefore, the transparent coating allows the packaging material to be distinctly seen through the coating on its surface. The skilled person can test whether a coating is transparent by eye or using methods known in the prior art.

The invention also provides methods for making a thixotropic aqueous mixture of the invention, and mixtures made by these methods. The methods for making a thixotropic aqueous mixture generally comprise at least one mixing step performed under high shear.

Therefore, in a second aspect, the invention provides a method of making a thixotropic aqueous mixture, comprising dispersing in water: a) at least one smectite clay; b) a water-soluble polymer; and c) a cross-linking agent capable of cross-linking the smectite clay to the polymer. In some embodiments, the smectite clay is dispersed in water under high shear mixing conditions. In some embodiments, the smectite clay, water-soluble polymer, and cross-linking agent are dispersed in water under high shear mixing conditions.

The methods of the invention for making a thixotropic aqueous mixture involve at least one step performed under high shear. Any of the methods or method steps described herein that involve high shear mixing may be carried out using any known high shear mixer, such as a vane mixer, Cowles dissolver, or colloid mill. High shear mixing requires equipment with high RPM and horsepower that ensure the dispersion blade can reach top speeds of between 2,500 to 5,000 feet per minute. The high shear mixing process may take 1-2 hours. For mixing of smaller batches of composition, a high shear blender may be used. High shear methods are advantageous because they achieve rapid dispersion of the smectite clay in water, and/or rapid mixing of the smectite clay, water-soluble polymer and/or cross-linking agent in water to form a thixotropic aqueous mixture that ensures an even dispersal of smectite clay particles (platelets). When using standard mixing methods that do not involve high shear (such as a tank with paddle mixer), mixing of smectite clay with water-soluble polymer, cross-linking agent, and/or other components in water will never fully disperse the smectite clay to form an evenly dispersed mixture. This is because the smectite clay platelets are held together in stacks by many weak bonds, such as hydrogen bonds and ion dipole interactions, which collectively amount to a large cohesive force. Standard mixing is not sufficient to overcome this cohesive energy. When using a method that involves high shear, the increased energy and substantial force imposed by the high shear is sufficient to break the forces that holds these smectite clay platelets together. Thus, a method of making the mixture of the invention using high shear is highly efficient.

In some embodiments, the smectite clay and the crosslinking agent are combined in powder form, and then this clay and crosslinker “pre-mix” is combined with (e.g., added to) water, and mixed under high shear mixing conditions to disperse the smectite clay and crosslinking agent in the water and allow the cross-linking agent to ion exchange to the surface of the smectite clay, to form a surface-modified smectite clay dispersion. In some embodiments, the smectite clay, the cross-linking agent, and the water-soluble polymer are mixed together in powder form, and then this smectite clay, cross-linker, and water-soluble polymer “pre-mix” is added to the water and mixed under high shear mixing conditions.

Alternatively, it is contemplated that the smectite clay, the water-soluble polymer, and the cross-linking agent are added separately to water and mixed under high shear. In these embodiments, adding components “separately” encompasses adding the components to the water simultaneously, or adding each component sequentially. Thus, in some embodiments, the method comprises adding the smectite clay to water, followed by high shear mixing to form an aqueous colloidal dispersion of smectite clay in water, and then adding the cross-linking agent and the water-soluble polymer to the aqueous colloidal dispersion, optionally followed by further high shear mixing. In other embodiments, the method comprises adding the smectite clay and the cross-linking agent to water, followed by mixing under high shear, and then adding the water-soluble polymer to the mixture, optionally followed by further high shear mixing.

In some embodiments, a thixotropic aqueous mixture is prepared by a) dispersing the smectite clay in water to form a smectite clay dispersion; b) adding a cross-linking agent to the smectite clay dispersion and allowing the cross-linking agent to ion exchange to the surface of the smectite clay, to form a surface-modified smectite clay dispersion; and then c) adding the water-soluble polymer to the surface-modified smectite clay dispersion. At least one of steps a), b), and c) may be performed under high shear conditions. For example, step a) of dispersing the smectite clay in water to form a smectite clay dispersion may be performed by high shear mixing. Thus, it is contemplated that the method may comprise adding smectite clay to water, followed by high shear mixing to form an aqueous colloidal dispersion of smectite clay in water, and then adding the cross-linking agent to the aqueous colloidal dispersion, optionally followed by further high shear mixing, and then adding the water-soluble polymer to the mixture, optionally followed by further high shear mixing.

The method is performed under conditions in which the cross-linking agent ion exchanges with the surface of the smectite clay and thereby becomes linked to the surface of the smectite clay, forming a surface-modified smectite clay. In some embodiments, the cross-linking agent is an amino acid, as described herein. In some embodiments, an amine group of the cross-linking agent (e.g., amino acid) ion exchanges with ions on the smectite clay surface, thereby linking the cross-linking agent to the surface of the smectite clay. For example, the amine group of an amino acid, optionally aminocaproic acid, ion exchanges with sodium ions on the surface of a smectite clay, optionally montmorillonite or Laponite, thereby forming an amino acid-modified smectite clay. In some embodiments, the pH of the dispersion needs to be adjusted in order to initiate the ion exchange and link the cross-linking agent to the smectite clay. For example, it may be necessary to lower the pH of the dispersion in order to protonate the amine group of an amino acid cross-linking agent so that it is cationic and can exchange for ions (e.g., sodium ions) on the surface of the smectite clay. For example, it may be necessary to adjust the pH of the dispersion to an acidic pH, such as pH 2-3. Therefore, in these embodiments, the method further comprises adjusting the pH of the dispersion to link the cross-linking agent to the surface of the smectite clay. In some embodiments, the pH is adjusted to an acidic pH. In some embodiments, the pH is adjusted to pH 2-3. The pH can be adjusted by any means known in the art. For example, in some embodiments, the method comprises adding any mineral acid, such as HC1, to the dispersion in order to adjust the pH to the desired pH value, such as pH 2-3.

In some embodiments, the thixotropic aqueous mixture is prepared by a) dispersing the smectite clay in water to form a smectite clay dispersion; b) adding a cross-linking agent to the smectite clay dispersion and adjusting the pH of the smectite clay dispersion to link the cross-linking agent to the surface of the smectite clay, to form a surface-modified smectite clay dispersion; and c) adding the water-soluble polymer to the surface-modified smectite clay dispersion. For example, step b) of this method may comprise adjusting the pH of the smectite clay dispersion to pH 2-3. In some embodiments, the pH is adjusted by adding a mineral acid, such as HC1 to the smectite clay dispersion. At least one of steps a), b), and c) may be performed under high shear conditions, as described herein.

The description and definitions provided herein in the context of the thixotropic aqueous mixture of the first aspect of the invention also apply to methods for making a thixotropic aqueous mixture of the invention. In particular, the smectite clay, the water-soluble polymer, and the cross-linking agent used in these methods can each be any of the smectite clays, water-soluble polymers, and cross-linking agents (respectively) described herein in the context of the thixotropic aqueous mixtures of the invention. In some embodiments, the at least one smectite clay is montmorillonite or Laponite, the water-soluble polymer is PVOH, and the cross-linking agent is aminocaproic acid, aminocaproic acid ethyl ester, or lysine. The smectite clay, the water-soluble polymer, and/or the cross-linking agent can each be used in the amounts and/or ratios described in the context of the thixotropic aqueous mixtures of the invention.

The invention also provides a thixotropic aqueous mixture made by any of the methods of the invention, which comprises at least one smectite clay, a water-soluble polymer, and a cross-linking agent, each as described herein. The invention further provides a thixotropic aqueous mixture made by any of the methods of the invention, which comprises at least one surface-modified smectite clay and a water-soluble polymer, each as described herein.

It is contemplated that any of the methods of the invention for making a thixotropic aqueous mixture of the invention may further comprise applying the thixotropic aqueous mixture to the surface of a packaging material. The thixotropic aqueous mixture can be applied to the surface of the packaging material using any means known in the art, so as to form a coating on the surface of the packaging material.

In a third aspect, the invention provides methods for preparing a coated packaging material. The methods generally comprise applying a thixotropic aqueous mixture of the invention to a surface of a packaging material and then heat-treating the surface to initiate cross-linking between the smectite clay and the water-soluble polymer via the cross-linking agent. In some embodiments, the thixotropic aqueous mixture is applied to a surface of a packaging material via a high-shear technique.

Therefore, invention provides a method for making a coated packaging material, comprising: i) applying a thixotropic aqueous mixture to a surface of the packaging material, wherein the thixotropic aqueous mixture comprises: a) at least one smectite clay; b) a water soluble polymer; and c) a crosslinking agent capable of cross-linking the smectite clay to the water-soluble polymer, to form a coating on the surface of the packaging material; ii) optionally drying the coating; and iii) cross-linking the water-soluble polymer to the smectite clay; thereby forming a coated packaging material. Alternatively, a method for making a coated packaging material comprises: i) applying a thixotropic aqueous mixture to a surface of the packaging material, wherein the thixotropic aqueous mixture comprises: a) at least one surface-modified smectite clay and b) a water soluble polymer; to form a coating on the surface of the packaging material; ii) optionally drying the coating; and iii) cross-linking the water-soluble polymer to the surface-modified smectite clay; thereby forming a coated packaging material.

Coating the surface of the packaging material with the thixotropic aqueous mixture of the invention provides one or more technical effects as described herein. In some embodiments, the coating enhances one or more barrier properties of the packaging material, for example, the coating acts as a gas barrier. The consistency and barrier properties of the coating are substantially retained in humid conditions. In particular, a coating formed by application of the thixotropic aqueous mixture of the invention does not become tacky or lose its gas barrier properties in humid conditions. Therefore, in some embodiments, a method of the invention for making a coated packaging material improves one or more barrier properties of the packaging material, compared to the same packaging material that is uncoated or coated with a conventional barrier coating.

Accordingly, in a fourth aspect, the invention provides methods of improving one or more barrier properties of a packaging material. The methods generally comprise i) applying a thixotropic aqueous mixture to a surface of the packaging material, wherein the thixotropic aqueous mixture comprises: a) at least one smectite clay; b) a water soluble polymer; and c) a cross-linking agent capable of cross-linking the smectite clay to the water-soluble polymer, to form a coating on the surface of the packaging material; ii) optionally drying the coating; and iii) cross-linking the water-soluble polymer to the smectite clay; thereby forming a coated packaging material, whereby one or more barrier properties of the coated packaging material is improved, compared to uncoated packaging material. Alternatively, the methods comprise: i) applying a thixotropic aqueous mixture to a surface of the packaging material, wherein the thixotropic aqueous mixture comprises: a) at least one surface-modified smectite clay and b) a water soluble polymer; to form a coating on the surface of the packaging material; ii) optionally drying the coating; and iii) cross-linking the water-soluble polymer to the surface-modified smectite clay; thereby forming a coated packaging material, whereby one or more barrier properties of the coated packaging material is improved, compared to uncoated packaging material. In some embodiments, the thixotropic aqueous mixture is applied to the surface of the packaging material using a high shear technique, as described herein. Typically, the cross-linking is initiated by heat treatment, optionally at a temperature in the range of 200-250 °C, optionally at about 225 °C, as described herein.

The invention further provides uses of any of the thixotropic aqueous mixture of the invention. In particular, in a fifth aspect, the invention provides the use of a thixotropic aqueous mixture comprising: a) at least one smectite clay, b) a water-soluble polymer, and c) a cross-linking agent capable of cross-linking the smectite clay to the polymer, as a coating for a packaging material, or for improving one or more barrier properties of a packaging material.

The description and definitions provided herein in the context of the thixotropic aqueous mixture of the first aspect of the invention also apply to the methods and uses of the third, fourth, and fifth aspects of the invention for making a coated packaging material and for improving one or more barrier properties of a packaging material. In particular, the thixotropic aqueous mixture used in the methods and uses of the invention can be any of the thixotropic aqueous mixtures of the invention described herein, and the smectite clay, the water-soluble polymer, and the cross-linking agent used in these methods and uses can each be any of the smectite clays, water-soluble polymers, and cross-linking agents (respectively) described herein in the context of the thixotropic aqueous mixtures of the invention. In some embodiments, the at least one smectite clay is montmorillonite or Laponite, the water-soluble polymer is PVOH, and the cross-linking agent is aminocaproic acid, aminocaproic acid ethyl ester, or lysine. The smectite clay, the water-soluble polymer, and/or the cross-linking agent can each be used in the amounts and/or ratios described in the context of the thixotropic aqueous mixtures of the invention. In some embodiments, the thixotropic aqueous mixture used in the methods and uses for making a coated packaging material or improving one or more barrier properties of a packaging material is made using a method according to the second aspect of the invention.

In methods of the invention that involve application of thixotropic aqueous mixture to a surface of packaging material, the thixotropic aqueous mixture can be applied using any one or more means known in the art, so as to form a coating on the surface of the packaging material. For example, the thixotropic aqueous mixture may be applied to the packaging material surface by dipping the packaging material, or a surface thereof, into the thixotropic aqueous mixture, and/or the thixotropic aqueous mixture may be sprayed and/or brushed onto the surface of the packaging material. Further means for applying the thixotropic aqueous mixture to paper or cardboard include ink jet printing, (roto)-gravure, or doctor knife, or a combination thereof.

In some embodiments, the thixotropic aqueous mixture is applied by dipping the packaging material or a surface thereof into a tank containing the thixotropic aqueous mixture. In some embodiments, the packaging material or a surface thereof is dipped into the thixotropic aqueous mixture at least once, such as about two or three times, or as often as necessary to achieve a coating of the desired thickness. After application of the mixture, the packaging material may be placed onto a draining belt to remove excess mixture. Optionally, after application of the mixture by dipping, a brush (e.g. a brush bed) is used to evenly and efficiently coat the packaging with a comprehensive coating of the thixotropic aqueous mixture of the invention.

Alternatively, or in addition, the thixotropic aqueous mixture is applied by spraying the mixture onto the surface of the packaging material (e.g., using a paint sprayer gun), optionally by a combination of spraying and brushing.

In some embodiments, the application method involves high shear. By way of example, it is contemplated to apply the thixotropic aqueous mixture to the surface of a packaging material using a paint sprayer gun, which comprises a pump and at least one nozzle for spraying thixotropic aqueous mixture onto the surface of the packaging material. In the application stage, the high shear imparted by the pump and spray nozzles of the spray gun lowers the viscosity of the thixotropic aqueous mixture and lessens the resistance to flow when applying the thixotropic aqueous mixture to the surface of the packaging material. Once the spray of the thixotropic aqueous mixture impinges upon the surface of the packaging material (i.e., the thixotropic aqueous mixture meets the surface of the packaging material), the viscosity recovers and forms a uniform coating on the surface of the packaging material. This advantageous feature, observed during the application of the thixotropic aqueous mixture of the invention, is due to the non-Newtonian fluid dynamics of the thixotropic mixture. In some embodiments, the thixotropic aqueous mixture is sprayed onto the surface of the packaging using the spray bar and then a brush is used as described above to increase the comprehensiveness of the coating.

Following application, the method optionally comprises drying the coating on the surface of the packaging material (e.g., by applying heat), but more typically the coating is left to dry naturally on the surface of the packaging material under ambient conditions.

In some embodiments, the thixotropic aqueous mixture applied to the surface of the packaging material comprises surface-modified smectite clay-i.e., smectite clay that is modified by the cross-linking agent, for example by ion exchange with the amine group of the cross-linking agent as described herein. Following application of the thixotropic aqueous mixture to a surface of the packaging material, the surface-modified smectite clay is cross-linked to the water-soluble polymer. The cross-linking agent at the surface of the smectite clay becomes linked to the water-soluble polymer via an ester linkage. Any means known in the art may be used to initiate the cross-linking reaction. For example, cross-linking may be initiated by heat treatment, optionally at 200-250 °C, optionally at about 225 °C. In some embodiments, after applying the thixotropic aqueous mixture to a surface of the packaging material to form a coating on the surface of the packaging material, and optionally drying the coating, the methods of the invention comprise heating the coating on the surface of the packaging material to cross-link the water-soluble polymer to the smectite clay, optionally under vacuum. The heat treatment may be at a temperature in the range of 200-250 °C, optionally at about 225 °C. Heat treatment may be continued for as long as necessary to initiate, or complete, the cross-linking reaction. For example, the coating may be heated for a duration of 1 to 4 hours. The Examples demonstrate the use of heat treatment for two hours at about 225 °C.

The term “packaging material” as used herein in connection with all aspects of the invention includes paper, cardboard, and plastic packaging materials.

Paper packaging material is used in the produce industry, to wrap and cushion produce, such as fruit, post-harvest. For example, pear paper is used to wrap pears to protect them from damage during transport. It is similar to paper utilized to wrap delicate items in gift wraps. Pear paper is quite thin and very porous. It would be advantageous to improve one or more barrier properties of paper packaging materials, for example paper packaging materials used in the produce industry, such as pear paper. Therefore, in some embodiments of the methods of the invention, the packaging material is paper, such as pear paper.

The produce industry also uses cardboard packaging materials, such as boxes and cartons, to transport produce, such as fruit, post-harvest. Cardboard also has poor barrier properties. It would be advantageous to improve one or more barrier properties of cardboard packaging materials. Therefore, in some embodiments of the methods of the invention, the packaging material is cardboard.

Porous plastics such as polyethylene terephthalate (PET), polypropylene (PP), and polyethylene (PE) are used in the produce industry, and more generally for packaging food and drink. PET is the most commonly used plastic for making plastic bottles, such as water or soda bottles. It would be advantageous to improve the barrier properties of porous plastic packaging materials such as PET. Therefore, in some embodiments of the methods of the invention, the packaging material is plastic, optionally porous plastic, optionally PET.

In some embodiments, the thixotropic aqueous mixture is applied to a surface of a packaging material before it is used to package a product, but in other embodiments the thixotropic composition is applied to the packaging material after it has been used to package a product-i.e., once the product is enclosed within the packaging material.

In some embodiments, the thixotropic aqueous mixtures, methods, and uses of the invention reduce the gas permeability of the coated packaging material, compared to uncoated packaging material. In these embodiments, the coating of thixotropic aqueous mixture acts as a gas barrier. A reduction in gas permeability may, for example, be a reduction in the rate of gas transfer through the surface of the packaging material.

The barrier properties of packaging material, including gas permeability, can be tested by any means known in the art. Standard tests and apparatus for measuring gas permeability are known in the art. For example, the gas barrier properties of paper or cardboard can be assessed using a pressure diffusion apparatus comprising a chamber that can be pressurized (e.g., to 2 to 3 atmospheres) and monitored continuously for pressure. Paper or cardboard to be tested can be mounted in an orifice of the chamber prior to pressurization of the chamber (e.g., to 2 to 3 atmospheres). The gas permeability of the paper or cardboard is judged by the time required for the chamber to reduce from pressurized (e.g., 2 atmospheres of pressure) down to ambient. Using this technique, the gas permeability of a packaging material is demonstrated to be reduced (i.e., the gas barrier properties are increased) if the length of time required for the chamber to reduce from pressurized (e.g., 2 atmospheres of pressure) down to ambient is increased.

The gas permeability of a packaging material surface coated with a thixotropic aqueous mixture of the invention is reduced as compared to the same packaging material surface that is not coated with a thixotropic aqueous mixture of the invention. A packaging material surface that is not coated with a thixotropic aqueous mixture of the invention (i.e., “uncoated”) may have a different coating, or may have no coating of any kind.

In some embodiments, the methods and uses of the invention provide protection from oxygen or carbon dioxide transfer though the surface of the packaging material. For example, application of a coating of the thixotropic aqueous mixture of the invention to a surface of a packaging material may reduce gas transfer, such as oxygen, though the surface of the packaging material, as compared to uncoated packaging material. This may be of particular utility when the packaging material to be used to package a product that is sensitive to oxidation, such as produce. Alternatively, or in addition, application of a coating of the thixotropic aqueous mixture of the invention to a surface of a packaging material may reduce loss of carbon dioxide though the surface of the packaging material, as compared to uncoated packaging material. This may be of particular utility when the packaging material to be used to package a carbonated drink, to prevent the drink from going flat. In other embodiments, the protection is from moisture loss, such as or including water vapor loss, through the surface of the packaging material. This may be of particular utility when the packaging material to be used to package a product that is sensitive to dehydration, such as produce. In other embodiments, the protection is from liquid ingress, such as oil, fats and water, through the surface of the packaging material. This may be of particular utility when the packaging material to be used to package a product that is sensitive to spoilage through exposure to liquids during storage, such as produce. Therefore, the method provides for improved gas barrier and/or moisture barrier properties, as compared to uncoated packaging. The thixotropic aqueous compositions and related methods of the invention are useful for reducing or even preventing the transmission rate of gas and/or moisture through the surface of the packaging material to which the thixotropic aqueous mixture is applied, as compared to the transmission rate through an uncoated surface. A reduction in gas transfer and/or moisture loss (e.g., water loss) may be defined in comparison to the gas transfer and/or moisture loss (e.g., water loss) through the same surface of a packaging material without any coating composition (uncoated control), or in comparison to the oxygen ingress and/or moisture loss (e.g., water loss) through the same surface of a packaging material coated with a conventional composition known in the art.

The thixotropic aqueous mixtures and methods of the invention are particularly useful for preventing oxygen transfer across the surface of packaging materials for packaging produce, such as fruit and vegetables. By reducing oxygen transfer (e.g. oxygen transmission rate) across a surface of packaging material used to package produce, the thixotropic compositions and methods of the invention are useful for protecting the produce from oxidation. Oxidation of produce, such as fruits (e.g., pome fruit) and vegetables, causes browning and softening of the produce, which reduces the produce shelf-life. Methods are known in the art for observing and measuring oxidation of produce such as fruit. For example, browning and/or softening of fruit, especially pome fruit, is typically observed and measured by eye.

Dehydration of produce is accelerated in drier environmental conditions and with exposure to air/oxygen. For example, water is lost from produce, such as fruit (e.g., pome fruit) and vegetables, during storage. The thixotropic aqueous mixtures and methods of the invention are particularly useful for preventing moisture loss across the surface of packaging materials for packaging produce. Produce may be more vulnerable to dehydration when stored or transported in drier atmospheric conditions. By reducing moisture loss (e.g. moisture vapor transmission rate) across a surface of packaging material used to package produce, the thixotropic compositions and methods of the invention are useful for protecting the produce from dehydration, by reducing or even preventing moisture loss from the produce across the surface of the packaging material. Methods are known in the art for observing and measuring dehydration of produce. For example, dehydration may be measured by weighing the produce, where a loss of weight corresponds to loss of moisture.

The shelf-life of fresh produce, and other food and drink products, may be defined as the length of time that the product may be stored without becoming unfit for use, consumption, or sale. During the shelf-life of a product, the defined quality of a specified proportion of the product remains acceptable under expected (or specified) conditions. Dehydration and/or oxidation of a product may reduce its shelf-life. Therefore, coated packaging materials prepared using the mixtures and methods of the invention are useful for protecting products such as produce from dehydration and/or oxidation and thereby maintaining the product's expected shelf-life or improving the product's shelf-life. An “improvement” in shelf-life may be an extension of the length of time that the product may be stored without becoming unfit for use, consumption, or sale. The improvement in shelf-life is achieved in comparison to the shelf-life of the same agricultural product without any coating composition uncoated control), or in comparison to the shelf-life of the same agricultural product coated with a conventional composition known in the art.

In a sixth embodiment, the invention provides a coated packaging material prepared by any of the methods of the invention. In some embodiments, the coated packaging material is or comprises paper or cardboard. In some embodiments, the coated packaging material is or comprises plastic, optionally porous plastic such as PP, PE, and/or PET. The coated packaging material comprises, on at least one surface, a coating of a thixotropic aqueous mixture of the invention, wherein the smectite clay is cross-linked to the water-soluble polymer.

The invention further provides, in a seventh embodiment, packaging made from a coated packaging material of the invention. For example, a box, carton, tray, bag, or bottle comprising the coated packaging material of the invention. Boxes, cartons, trays, and bags comprising paper, cardboard, and/or plastic are used in the produce industry to package fruit and vegetables. Boxes, cartons, trays, bags and bottles comprising plastic, especially porous plastics such as PET, are used in the produce, and food and drink industries.

### Thixotropic Mixtures Comprising Smectite Clay and Water-Soluble Polymer

In a further aspect, the present invention provides a series of treated paper products to package produce comprising at least one smectite clay and a water-soluble polymer. The invention thus provides a composition to coat paper with a thixotropic aqueous mixture of at least one smectite clay and a water-soluble polymer. In some embodiments, the at least one smectite clay to water-soluble polymer ratio is between 1:4 and 4:1, such as about to 1:1. The composition may comprise an aqueous dispersion of between 1 and 5% solids. Suitable smectite clays for use in the composition include montmorillonite, sodium hectorite, Laponite, or mixtures thereof. Suitable water-soluble polymers for use in the composition include gum Arabic, pectin, or polyvinyl alcohol (PVOH).

The present invention provides a method of making a series of thixotropic mixtures comprising at least one smectite clay and a water-soluble polymer and optionally applying said mixture to paper or cardboard. The at least one smectite clay and water-soluble polymer are added with high shear mixing to water then optionally applied to paper via a tank, spray bar, brush, inkjet printer, doctor knife, roto gravure or combination thereof. In an embodiment of the invention, the at least one smectite clay and water-soluble polymer are premixed in powder form and then the mixture is added to water with high shear mixing. In another embodiment of the invention, the at least one smectite clay and water-soluble polymer are added separately to water with high shear mixing.

The invention also provides a method for coating paper using the coating composition comprising a thixotropic aqueous mixture of at least one smectite clay and a water-soluble polymer, and a paper coated in accordance with this method. For example, the invention provides a method of applying the composition to the surface of paper, wherein the composition is applied by a doctor knife, inkjet printer, a spray bar, dip tank, brush, roto gravure or combination thereof. The composition described herein can be applied to paper via a dip tank, spray bar, brush bed, inkjet printer, doctor knife, roto gravure, or other method that completely coats the paper with the thixotropic mixture. The preferred method of application of the coating to the paper in the disclosed composition is using a rotogravure to allow for high speed coating and also patterning if desired.

The invention also provides methods of making a series of coated paper coated with a thixotropic fluid comprising at least one smectite clay and a water-soluble polymer and applying said mixture to select paper products. The at least one smectite clay and water-soluble polymer are added to water, mixed under high shear, and then applied to paper via a dip tank, spray bar, brush, doctor knife, ink jet printer, rotogravure, or combination thereof. The coating is then dried in an oven. This method of coating paper or cardboard with the at least one smectite clay and water-soluble polymer composition increases the resulting barrier properties.

The at least one smectite clay portion of the composition may be sodium montmorillonite, sodium hectorite, and Laponite, and mixtures thereof. Water-soluble polymers for use in the invention include gum Arabic, pectin, and polyvinyl alcohol. A preferred embodiment of the composition is a smectite clay and polyvinyl alcohol. It is contemplated that the coating composition as used according to some embodiments of the invention comprises at least one smectite clay in an amount from 0.5 to 2.5 weight % by volume of the total composition. In some embodiments, the coating composition as used according to the invention comprises a water-soluble polymer in an amount from 0.5 to 2.5 weight % by volume of the total composition. Various ratios of at least one smectite clay to water-soluble polymer are contemplated herein. In one embodiment, the at least one smectite clay to water-soluble polymer ratio of the composition is between 1:4 and 4:1. In another embodiment, the at least one smectite clay to water-soluble polymer ratio of the composition is to 1:1. In yet another embodiment, the aqueous dispersion of the composition is between 1 and 5% solids.

### Thixotropic Mixtures Comprising Smectite Clay and Vegetable Oil

A further aspect of the present invention is to coat cardboard with a thixotropic mixture of a surface modified clay and a vegetable oil in a suitable solvent to produce a coated cardboard that is resistant to oils, fats and water. Cardboard coated with this thixotropic mixture is well-suited for packaging food products that have a high fat or oil content, or a high water content, as an alternative to wax-coated packaging materials used in the food packaging business. Further, the coated cardboard is compostable and does not require landfilling. A method of coating cardboard that is resistant to oils, fats and water to replace wax coated boxes especially in the meat industry is disclosed. In an embodiment of the invention, cardboard is coated with a thixotropic fluid comprising at least one surface modified smectite clay and a vegetable oil. The at least one smectite clay and vegetable oil are added with high shear mixing to a suitable solvent then applied to paper via a dip tank, spray bar, brush, doctor knife, ink jet printer, rotogravure, or combination thereof. The coating is then dried in an oven. This method of coating cardboard with the at least one smectite clay and a vegetable oil composition increases the cardboard's resistance to absorbing fats, oils or water from meats or produce packaged within them. Unlike plastic packaging known in the art, this coated cardboard is compostable and does not require landfilling.

The invention thus provides a composition for coating cardboard, wherein the composition is comprised of a surface modified smectite clay and a vegetable oil in a suitable solvent to produce a coated composite that is resistant to oil, fats and water.

The invention also provides a method for coating cardboard with this composition to increase resistance to oil, fats and water, wherein the method comprises: (i) adding a smectite clay and a vegetable oil with high shear mixing to a suitable solvent; (ii) applying the composition to cardboard; and (iii) drying the coated cardboard in an oven. Further, a method is provided for preparing a coated cardboard, comprising applying a thixotropic mixture to the surface of the cardboard, wherein the thixotropic mixture comprises smectite clay and vegetable oil. The thixotropic mixture can be applied to the surface of the cardboard via any known means, such as via a dip tank, spray bar, brush bed, inkjet printer, doctor knife, roto gravure, or any combination thereof. In some embodiments, the thixotropic mixture is prepared by a method comprising adding smectite clay and vegetable oil with high shear mixing to a solvent. A suitable solvent may comprise or consist of water; optionally a mixture of water and a volatile solvent such as ethanol. In some embodiments, after applying the thixotropic mixture to the cardboard, the method further comprises drying the coated cardboard in an oven and/or air-drying the coated cardboard.

In any embodiment of this aspect of the invention, the smectite clay can be montmorillonite, hectorite, Laponite, or a mixture of any two or more thereof; optionally sodium montmorillonite.

The surface of a smectite clay is partly or even substantially hydrophilic. Due to their hydrophilic nature, unmodified smectite clays do not disperse well within vegetable oils and thus, preparation of a composition comprising a smectite clay and a vegetable oil is challenging. In some embodiments, a compatibilizing agent is included in the mixture to hydrophobically-modify the smectite clay. In general, a “compatibilizing agent” is an organic modifier that reacts with a substance and hydrophobically-modifies the substance. In particular, the term “compatibilizing agent”, as used herein, refers to an agent that hydrophobically-modifies (“hydrophobes”) the smectite clay in the mixture, thereby rendering the smectite clay “hydrophobically-modified”. Compatibilizing agents react with smectite clay to hydrophobically modify the smectite clay particles and thereby make the clay compatible with hydrophobic polymers. Specifically, compatibilizing agents react with the smectite clay by bonding to exchangeable sodium ions on the surface of the clay via ion-dipole bonding of the OH groups, thereby converting the smectite clay surface from hydrophilic to hydrophobic. Commonly-used compatibilizing agents include ionic liquids. Ionic liquids may be comprised of a combination of organic cations, including: ammonium, phosphonium, sulfonium, imidazolium, pyrrolidinium, piperidinium and/or pyridinium, with several organic and inorganic anions. Compatibilizing agents useful in the invention include sodium citrate, mono-or di-glycerides of a natural fats, and/or mono-or di-esters of pentaerythritol, such as an octadecyl monoester of pentaerythritol.

In some embodiments, the at least one smectite clay is, or has previously been, hydrophobically-modified (e.g., made hydrophobic) by treatment with a compatibilizing agent. Thus, the smectite clay in the thixotropic mixture of the invention is a “hydrophobically-modified smectite clay”. A “hydrophobically-modified smectite clay”, as used herein, refers to a smectite clay that has been hydrophobically-modified (“hydrophobed”). The surface of a hydrophobically-modified smectite clay is substantially hydrophobic, and may be entirely hydrophobic. Accordingly, in some embodiments, a “hydrophobically-modified smectite clay” may be referred to as a “hydrophobic smectite clay”. Hydrophobically-modified smectite clay (e.g., hydrophobic smectite clay) has the advantageous feature of being repellent to water, as opposed to interacting with or absorbing water.

A known method of determining whether a smectite clay is hydrophobic or hydrophilic is to use a contact angle measurement. Using standard contact angle measurement equipment known in the art, the contact angle of water droplets on smectite clay can be measured. Water droplets form on hydrophobic surfaces, indicating that the cohesive forces associated within the droplet are greater than the forces associated with the interaction of water with the smectite clay surface. A contact angle greater than 90° between the surface of the smectite clay and the water droplet indicates that the clay is hydrophobic.

This aspect of the invention also pertains to a method of improving one or more barrier properties of cardboard, comprising: coating the cardboard with a thixotropic mixture comprising smectite clay and vegetable oil, optionally using a method as described herein; whereby one or more barrier properties of the coated cardboard is improved, compared to uncoated cardboard. In some embodiments, the one or more barrier properties of the cardboard is gas permeability, and the gas permeability of the coated cardboard is reduced, compared to uncoated cardboard. In some embodiments, the one or more barrier properties of the cardboard is resistance to absorbing oil, fat, and/or water, and the resistance of the coated cardboard to absorbing oil, fat, and/or water is increased, compared to uncoated cardboard. Also provided is the use of a thixotropic mixture comprising smectite clay and vegetable oil as a coating for cardboard and/or for improving one or more barrier properties of cardboard. Also provided is cardboard coated with a thixotropic mixture comprising smectite clay and vegetable oil; and a packaging material for produce or meat, comprising the coated cardboard.

The terms “comprising,” “including,” and “having,” as used in the claims and specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition or step being referred to is an optional (not required) feature of the invention.

The invention has been described with reference to various specific and preferred embodiments and techniques. However, it should be understood that many variations and modifications may be made while remaining within the spirit and scope of the invention. It will be apparent to one of ordinary skill in the art that methods, devices, device elements, materials, procedures and techniques other than those specifically described herein can be applied to the practice of the invention as broadly disclosed herein without resort to undue experimentation. All art-known functional equivalents of methods, devices, device elements, materials, procedures and techniques described herein are intended to be encompassed by this invention. Whenever a range is disclosed, all subranges and individual values are intended to be encompassed. This invention is not to be limited by the embodiments disclosed, including any shown in the drawings or exemplified in the specification, which are given by way of example and not of limitation.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

All references throughout this application, for example patent documents including issued or granted patents or equivalents, patent application publications, and non-patent literature documents or other source material, are hereby incorporated by reference herein in their entireties, as though individually incorporated by reference, to the extent each reference is at least partially not inconsistent with the disclosure in the present application (for example, a reference that is partially inconsistent is incorporated by reference except for the partially inconsistent portion of the reference).

### EXAMPLES

### Comparative Example 1

As a base line to investigate the coating of the invention, pear paper was chosen as a substrate. Pear paper is utilized to wrap pears in to protect them from damage in the carton during transport. It is similar to paper utilized to wrap delicate items in gift wraps. The paper is quite thin and very porous. A chamber that has the ability to be pressurized to 2 to 3 atmospheres was constructed to test the gas permeability of the substrate. The chamber can be monitored continuously for pressure. It is equipped with an orifice of ½ diameter where a disk of the paper of interest can be mounted. The disk is backed by a wire mesh to give it physical strength to withstand the pressure.

A disk of the pear paper was mounted in the chamber orifice and an attempt to pressurize the chamber to a delta of two atmospheres was made. The pear paper was so porous that two atmospheres could not be reached. After shutting off the pressure the chamber reached ambient pressure after 15 seconds.

### Comparative Example 2

Pear paper was placed in a stretcher frame and then coated by gently spraying the paper with a thixotropic composition comprised of 2.5 % by weight sodium montmorillonite and 2.5% by weight polyvinyl alcohol in water. The paper was air dried. The treated paper was then tested for gas permeability in a pressure diffusion apparatus. The permeability was judged by the time required for the chamber to go from 2 atmospheres of pressure down to ambient. The untreated paper took only 1 second to reach ambient pressure. The treated paper took 3 minutes to reach ambient pressure, which is similar to microporous plastic packaging in current use.

### Comparative Example 3

In a further experiment, pear paper was dipped in a solution containing 3% by weight polyvinyl alcohol, and 2% sodium montmorillonite. The paper was then allowed to dry. This procedure was done successively two more times. Disks of the coated pear paper were then mounted in the pressure tester from each of the three dippings. The paper dipped once was able to reach two atmosphere differential and required one hour to reach ambient pressure. The paper dipped twice required 16 hours to reach ambient pressure. The paper that was dipped three times required 93 hours to return to ambient pressure.

In a further experiment, coatings with the same 3% PVOH, 2% sodium montmorillonite solution were applied with a paint sprayer gun on both sides of pear paper. The pear paper was applied with 1-3 coatings of the solution and allowed to dry. The pressure results were 53 minutes, 15 hours and 83 hours for 1, 2 and 3 coating cycles respectively to reach ambient pressure.

From these tests it was quite apparent that paper can be treated and improve barrier properties substantially. However, it was observed that high humidity or direct water contact caused the paper to become tacky and lose some of its barrier property.

### Example 4

In this example, to improve the properties of the coating, the polymer was crosslinked to the surface of the clay using a crosslinker. A 2% solution of montmorillonite was dispersed in water. 2.5 grams of aminocaproic acid was stirred into the liter of solution to facilitate crosslinking. The pH was adjusted to protonate the amine group of aminocaproic acid and facilitate ion exchange with sodium on the surface of the clay. 30 grams of polyvinyl alcohol was then dispersed into the solution containing the surface modified clay. Pear paper was dipped and dried three times in this solution. The paper thus treated was heat treated for two hours at 225 °C to initiate crosslinking of the polymer to the clay surface by forming an ester linkage. A subsequent pressure test yielded a value of 105 hours to return to ambient pressure. The treated paper did not become tacky upon exposure to water directly.

The same procedure was followed except the ethyl ester of aminocaproic acid was utilized as the surface modifier/crosslinker. The pressure results and water stability were almost identical to paper coatings crosslinked with aminocaproic acid.

### Example 5

In this example, a 2% solution of laponite was dispersed in water and 2.5 grams of aminocaproic acid was stirred into the liter of solution. The pH was adjusted to protonate the amine group of aminocaproic acid and facilitate ion exchange with sodium on the surface of the clay. Then 30 grams of polyvinyl alcohol was then dispersed into the solution containing the surface modified clay. 8 ounce PET soda bottles were dipped into this solution and allowed to dry. The transparent coating was then heat treated to initiate crosslinking of the polymer and clay. The resulting crosslinked coating was hydrolytically stable and yielded an 8 fold improvement in carbon dioxide permeability relative to the same 8 ounce PET soda bottles that were uncoated.

1. A thixotropic aqueous mixture for coating a packaging material, comprising:
a) at least one smectite clay;
b) a water-soluble polymer; and
c) a cross-linking agent capable of cross-linking the smectite clay to the polymer.

2. The thixotropic aqueous mixture of claim 1, wherein the cross-linking agent is an amino acid; optionally aminocaproic acid, aminocaproic acid ethyl ester, or lysine.

3. The thixotropic aqueous mixture of claim 1 or claim 2, wherein the smectite clay is montmorillonite, Laponite, hectorite, or a mixture of any two or more thereof; optionally wherein the smectite clay is sodium montmorillonite.

4. The thixotropic aqueous mixture of any one of claims 1-3, wherein the water-soluble polymer is polyvinyl alcohol, gum Arabic, or pectin, or a mixture of any two or more thereof; optionally wherein the water-soluble polymer is polyvinyl alcohol.

5. The thixotropic aqueous mixture of any preceding claim, wherein the thixotropic aqueous mixture comprises:
a) sodium montmorillonite or laponite;
b) polyvinyl alcohol; and
c) aminocaproic acid or its ethyl ester.

6. The thixotropic aqueous mixture of any preceding claim, wherein the smectite clay is present in the thixotropic aqueous mixture in an amount from 0.5 to 3.5 wt. %, optionally from 1.0 to 3.0 wt. %, optionally 2.0 wt %.

7. The thixotropic aqueous mixture of any preceding claim, wherein the water-soluble polymer is present in the thixotropic aqueous mixture in an amount from 1.5 to 4.5 % wt. %, optionally from 2.0 to 4.0 wt. %, optionally 3.0 wt %.

8. The thixotropic aqueous mixture of any preceding claim, wherein the cross-linking agent is present in thixotropic aqueous mixture in an amount from 0.1 to 0.4 wt. %, optionally 0.25 wt. %.

9. The thixotropic aqueous mixture of any preceding claim, wherein the ratio of smectite clay to water-soluble polymer is between 1:4 and 4:1, optionally wherein the ratio of smectite clay to water-soluble polymer is about 2:3.

10. The thixotropic aqueous mixture of any preceding claim, wherein the ratio of smectite clay to cross-linking agent is about 8:1; or the ratio of water-soluble polymer to cross-linking agent is about 12:1.

11. The thixotropic aqueous mixture of any preceding claim, wherein the thixotropic aqueous mixture is a dispersion comprising 1-8% solids; optionally 1-5% solids.

12. A method of making a thixotropic aqueous mixture, comprising dispersing in water:
a) at least one smectite clay;
b) a water-soluble polymer; and
c) a cross-linking agent capable of cross-linking the smectite clay to the polymer.

13. The method of claim 12, comprising:
a) dispersing the smectite clay in water to form a smectite clay dispersion;
b) adding the cross-linking agent to the smectite clay dispersion and adjusting the pH of smectite clay dispersion to link the cross-linking agent to the surface of the smectite clay, to surface-modified smectite clay dispersion; and
c) adding the water-soluble polymer to the surface-modified smectite clay dispersion.

14. A method for preparing a coated packaging material, comprising:
a) applying a thixotropic aqueous mixture to a surface of the packaging material, wherein the thixotropic aqueous mixture comprises:
i) at least one smectite clay;
ii) a water soluble polymer; and
iii) a cross-linking agent capable of cross-linking the smectite clay to the water-soluble polymer; and
b) cross-linking the water-soluble polymer to the smectite clay.

15. A method of improving one or more barrier properties of a packaging material, comprising:
a) applying a thixotropic aqueous mixture to a surface of the packaging material, wherein the thixotropic aqueous mixture comprises:
i) at least one smectite clay;
ii) a water soluble polymer; and
iii) a cross-linking agent capable of cross-linking the smectite clay to the water-soluble polymer;
and
b) cross-linking the water-soluble polymer to the smectite clay; whereby one or more barrier properties of the coated packaging material is improved, compared to uncoated packaging material.

16. The method of claim 15, wherein the one or more barrier properties of the packaging material is gas permeability, and wherein the gas permeability of the coated packaging material is reduced, compared to uncoated packaging material.

17. The method of any one of claims 14-16, wherein the thixotropic aqueous mixture is applied to the surface of the packaging material via a dip tank, spray bar, brush bed, inkjet printer, doctor knife, roto gravure, or any combination thereof.

18. The method of any one of claims 14-17, further comprising making the thixotropic aqueous mixture by a method according to claim 12 or claim 13.

19. The method of any one of claims 14-18, wherein the packaging material comprises or consists of paper, cardboard, and/or plastic.

20. Use of a thixotropic aqueous mixture comprising:
a) at least one smectite clay,
b) a water-soluble polymer, and
c) a cross-linking agent capable of cross-linking the smectite clay to the polymer, as a coating for a packaging material, or for improving one or more barrier properties of a packaging material.

21. The use of claim 20, wherein the packaging material comprises or consists of paper, cardboard, and/or plastic such as PET.

22. The method of any one of claims 12-19 or the use of claim 20 or 21, wherein the cross-linking agent is an amino acid; optionally aminocaproic acid, aminocaproic acid ethyl ester, or lysine.

23. The method or use of any one of claims 12-22, wherein the smectite clay is montmorillonite, Laponite, hectorite, or a mixture of any two or more thereof; optionally wherein the smectite clay is sodium montmorillonite.

24. The method or use of any one of claims 12-23, wherein the water-soluble polymer is polyvinyl alcohol, gum Arabic, or pectin, or a mixture of any two or more thereof; optionally wherein the water-soluble polymer is polyvinyl alcohol.

25. The method or use of any one of claims 12-24, wherein the thixotropic aqueous mixture comprises:
a) sodium montmorillonite or laponite;
b) polyvinyl alcohol; and
c) aminocaproic acid or its ethyl ester.

26. The method or use of any one of claims 12-25, wherein the smectite clay is present in the thixotropic aqueous mixture in an amount from 0.5 to 3.5 wt. %, optionally from 1.0 to 3.0 wt. %, optionally 2.0 wt %.

27. The method or use of any one of claims 12-26, wherein the water-soluble polymer is present in the thixotropic aqueous mixture in an amount from 1.5 to 4.5 % wt. %, optionally from 2.0 to 4.0 wt. %, optionally 3.0 wt %.

28. The method or use of any one of claims 12-27, wherein the cross-linking agent is present in thixotropic aqueous mixture in an amount from 0.1 to 0.4 wt. %, optionally 0.25 wt. %.

29. The method or use of any one of claims 12-27, wherein the ratio of smectite clay to water-soluble polymer in the thixotropic aqueous mixture is between 1:4 and 4:1, optionally wherein the ratio of smectite clay to water-soluble polymer is about 2:3.

30. The method or use of any one of claims 12-29, wherein the ratio of smectite clay to cross-linking agent in the thixotropic aqueous mixture is about 8:1; or the ratio of water-soluble polymer to cross-linking agent in the thixotropic aqueous mixture is about 12:1.

31. The method or use of any one of claims 12-30, wherein the thixotropic aqueous mixture is a dispersion comprising 1-8% solids; optionally 1-5% solids.

32. Coated packaging material prepared by the method of any one of claims 14-19 and 22-31.

33. The coated packaging material of claim 32, which comprises or consists of paper, cardboard, and/or plastic such as PET.

34. A box, carton, tray, bag, or bottle comprising the coated packaging material of claim 32 or claim 33.
